(19) United States
(12) Patent Application Publication
(10) Pub. No.: US 2024/0299879 A1
(43) Pub. Date: Sep. 12, 2024

(54) SULFIDE SCAVENGING AGGREGATE FOR THE CONSTRUCTION OF LANDFILL GAS WELLS

(71) Applicant: Heritage Research Group, LLC, Indianapolis, IN (US)

(72) Inventor: Perry Eyster, Brownsburg, IN (US)

(73) Assignee: Heritage Research Group, LLC, Indianapolis, IN (US)

(21) Appl. No.: 18/665,660

(22) Filed: May 16, 2024

Related U.S. Application Data
(63) Continuation of application No. PCT/US2022/050555, filed on Nov. 21, 2022.
(60) Provisional application No. 63/264,306, filed on Nov. 19, 2021.

(51) Int. Cl. B01D 53/52; B01D 53/82; B01J 20/06; B09B 1/00; C09K 8/54; E21B 43/38; E21B 49/08

(52) U.S. Cl. CPC B01D 53/52; B01D 53/82; B01J 20/06; B09B 1/006; C09K 8/54; E21B 43/38; B01D 2253/1124; B01D 2257/304; B01D 2258/05; C09K 2208/20; E21B 49/08

(57) ABSTRACT

In preferred embodiments, the present disclosure relates to wells and methods of using the same. The disclosure refers to a method for reducing noxious gas from a location. A location containing hydrogen sulfide may be identified. The well may be packed with a reactive structural component composed at least partially of a metal oxide. The well may be inserted into the location containing hydrogen sulfide. A gaseous mixture is extracted from the location. The reactive structural component reacts with the hydrogen sulfide to remove it from the gaseous mixture being extract. A metal sulfide is a byproduct of this process. Often, the location may be a landfill. The metal oxide may be iron oxide. The gas being extracted may be methane.

### CROSS REFERENCE TO RELATED APPLICATION

This application is the National Stage of International Application No. PCT/US2022/050555 filed Nov. 21, 2022, which claims the benefit of U.S. Provisional Application No. 63/264,306 filed Nov. 19, 2021, which is hereby incorporated by reference herein in its entirety.

### BACKGROUND OF THE INVENTION

Anaerobic environments of landfills allow for the production and collection of valuable methane gas which can be sold or be further used in operations. In addition to methane, other gases may also generated or collected. When other gases are mixed with methane, the purity of the methane gas may be decreased. A decrease in purity may lower the value of the methane gas. Therefore, there remains a need for improvement in this field.

### SUMMARY OF THE INVENTION

The anaerobic environment of landfills allows for the production of valuable methane gas. Other gases may also be generated in this environment including dangerous hydrogen sulfide gas. When there is insufficient value to justify capture of methane produced by a landfill, a flare may be deployed. Removing hydrogen sulfide may be necessary to capture full value from the methane or prevent exhausting sulfur dioxide from the flare stack. Typically, the gases may be collected through a series of well heads placed into an existing landfill cell or built concurrent to filling the cell with solid waste. The gases may then drawn through a collection system to a scrubber bed, or other sulfide abatement system. These systems can be expensive to operate and maintain in both capital and manpower. Often such systems may be unable to fully remove the sulfides and result in decreased gas value, odor issues, and exhaust concerns when gases are flared.

Some of the most reliable systems to remove hydrogen sulfide utilize forms of iron oxides to capture the gas as ferrous sulfide. Other systems produce various sulfur compounds or elemental sulfur. The capital cost, maintenance costs, and manpower diversion associated with this equipment is considerable. The described invention minimizes capacity constraints and the associated operational costs of these systems.

In some embodiments, the present disclosure relates to a method for removing a noxious gas from a mixture of gases. For example, methods may include the step of identifying a source of hydrogen sulfide. The source may be a landfill. A reactive structural component may be identified comprising a metal oxide. The reactive structural component may be integrated into the source of hydrogen sulfide, for example in a wellhead. The reactive structural component may be packed within the wellhead. The hydrogen sulfide may contact the structural component to produce a metal sulfide. In some embodiments, the metal oxide may comprise an iron oxide. More specifically, the metal oxide may include FeO.

In other embodiments, a well with an elongated piping system including an outer pipe and an inner pipe is disclosed. The outer pipe may include openings defining a fluid path that extends through the outer pipe. The outer pipe may be filled with a reactive structural component including metal oxide. The inner pipe may be nested within the outer pipe and define a channel through a length of the inner pipe. The inner pipe may include openings defining a fluid path operably connected to the fluid path of the outer pipe that extends through the inner pipe into the channel. Fluid from a fluid reservoir may flow into the well through fluid path defined by the openings in the outer pipe and into the channel of the inner pipe. The fluid may eventually travel to the surface for collection. In some embodiments, the metal oxide may comprise an iron oxide. More specifically, the metal oxide may include FeO. The reservoir of gas may comprise a landfill.

In additional embodiments, a method for reducing noxious gas from a location is disclosed. A location, for example a landfill, containing hydrogen sulfide may be identified. A well may be packed with a reactive structural component comprising a metal oxide. Often, the metal oxide may be iron oxide. The well may be inserted into the location containing hydrogen sulfide. A gaseous mixture may be extracted from the location. The reactive structural component may react with the hydrogen sulfide to remove it from the gaseous mixture being extract. A metal sulfide may be produced.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagrammatic view of one example of a well.

FIG. 2 is a flowchart illustrating an example of a process of removing a noxious gas from a mixture of gases.

### DESCRIPTION OF THE INVENTION

For the purpose of promoting an understanding of the principles of the disclosure, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the disclosure as described herein are contemplated as would normally occur to one skilled in the art to which the disclosure relates. One embodiment of the disclosure is shown in great detail, although it will be apparent to those skilled in the relevant art that some features that are not relevant to the present disclosure may not be shown for the sake of clarity.

A landfill is a site for the disposal of waste materials. Often, landfills may be layered to promote the breakdown of waste into simpler, less toxic compounds over time. Typically, aerobic decomposition is the first stage to breakdown the waste. Anaerobic decomposition often follows once oxygen is consumed. Anaerobic decomposition is a process by which microorganisms break down biodegradable material in the absence of oxygen. As the waste is placed in the landfill, the void spaces contain high volumes of molecular oxygen (O₂). With added and compacted wastes, the O₂ content of a landfill bioreactor strata gradually decreases. Microbial populations grow, density increases creating an anaerobic environment. Methane gas is released as a final end product of anaerobic decomposition. Methane has valuable applications as natural gas, for example to heat people's homes.

However, methane is not the only gas generated in a landfill. Often, noxious gases are generated that are harmful to humans during collection of the useful and/or valuable gases. Additionally, these noxious gases are harmful to the environment when inadvertently released during collection of the gases. One example of a noxious gas found in a landfill includes hydrogen sulfide (H₂S).

Often, noxious gases are present in such high concentrations that it makes collecting methane economically unviable. In some instances, a flare must be deployed to remove noxious gases. Removing this toxic gas is necessary to capture full value from the methane or prevent exhausting sulfur dioxide into the environment from the flare stack. Typically, gases are collected through a series of well heads placed into an existing reservoir. Often, the reservoir is a landfill. Well heads may be placed in a landfill cell or built concurrent to filling the cell with solid waste. Gases may then be drawn through a collection system to a scrubber bed or other sulfide abatement system. Such systems can be expensive to operate and maintain in both capital and manpower. Often, these systems are unable to fully remove the sulfides and result in decreased gas value, odor issues, and environmental exhaust concerns when gases are flared.

Some of the most efficient and effective systems used to remove noxious gases utilize forms of iron oxides to directly capture the gas as ferrous sulfide. Other systems produce various sulfur compounds or elemental sulfur. The capital cost, maintenance costs, and manpower diversion associated with this equipment is considerable.

The present disclosure utilizes low-cost metal oxides to serve as both a structural and reactive component of a wellhead. Depending on the vertical or horizontal well design, current systems utilize a cylindrical gravel bed encompassing the length or height of the porous pipe of the well to act as a structural barrier. The structural barrier separates the porous pipe from contents of the landfill. This also extends the surface area from which the gases can be evacuated.

In some embodiments, inert gravel may be replaced by properly sourced aggregate materials comprised of metal oxides. In some non-limiting examples, the metal oxide may be iron oxide, cobalt oxide, chrome oxide, copper oxide, manganese dioxide, nickel oxide. Other known metal oxides may be used as well. In some examples, a mixture of multiple metal oxides may be used in combination. The metal oxides may provide a structure component to a well. Advantageously, metal oxides react with the sulfide gases during extraction to secure them in an efficient operation within the landfill, itself. Therefore, the sulfide gases may be removed from gas mixture including methane. Additionally, the flow rate of gases may be lower at each wellhead and provides a kinetic advantage in securing the sulfides in-situ. The reactive metal oxides may be readily available as by-products.

One non-limiting example of such a reactive metal oxide material is Waelz slag. This material is the non-hazardous, iron oxide component remaining in the thermochemical removal of zinc from electric arc furnace (“EAF”) dust. Much of the EAF pellet material entering the Waelz kiln exits in a sintered form well-suited for the structural needs of the described disclosure. Further, this metal oxide maybe be largely in the more reactive ferrous (Iron (II) oxide, FeO) form. FeO provides greater iron content per unit volume of placed material. Once ferrous and the hydrogen sulfide react, ferrous sulfide may be produced. Advantageously, ferrous sulfide is stable similar to the iron sulfide that comprises the earth's crust. In this form, the ferrous sulfide may remain safely in place. The anoxic environment of the landfill will further secure this stable form.

Additional non-limiting sources of recovered iron oxides may include regeneration of spent pickling liquor. This may be recovered as a powder or aggregate particle, the ferric oxide can be formed into a reactive, synthetic gravel substitute.

Similarly, the iron oxides present in “red mud” impoundments can be pelletized, briquetted, or otherwise formed into a suitable reactive aggregate for use as a reactive structural component fill. Red mud, also known as bauxite residue, is an industrial waste generated during the processing of bauxite into alumina using the Bayer process. It is composed of various oxide compounds, including the iron oxides which give its red color.

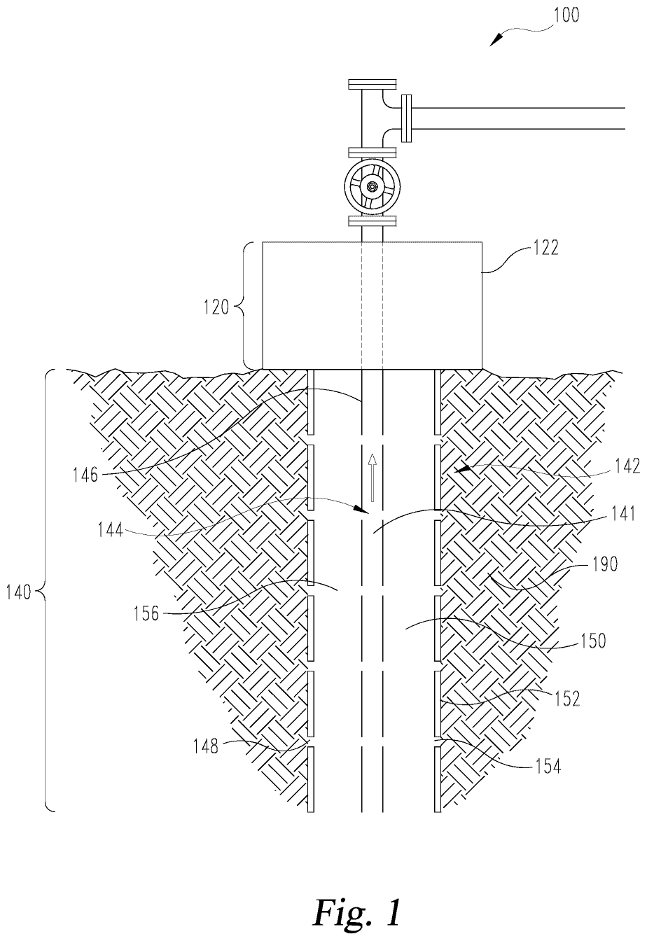

FIG. 1 illustrates a well 100. The well 100 is illustrated as a vertical land well. The well 100 may include an above ground portion 120 and a below ground portion 140. The above ground portion 120 may include a well head 122. The below ground portion 140 may include a vertical pipe 142. The vertical pipe 142 may be inserted within a reservoir 190. In some embodiments, the reservoir 190 may be a landfill.

The vertical pipe 142 may include an inner pipe 141 and an outer pipe 150. The outer pipe 150 may include an outer surface 152, creating a structural barrier between the well and the contents of the reservoir. The outer surface 152 of the outer pipe 150 may include openings/perforations 154 extending inward to the inner pipe 141. The perforations 154 may allow fluids from the reservoir 190 to flow through the outer surface 152 of the outer pipe 150 and into the inner pipe 141, where they may be taken to the surface and secured for use on site or transport to another location.

The outer pipe 150 may be filled with materials that compose a reactive structural component 156. In some embodiments, the reactive structural component 156 may include a metal oxide. In some embodiments, the metal oxide may be iron oxide. As the gas from the reservoir 190 passes through the reactive structural component 156 into the inner pipe 141. the reactive structural component 156 may react with noxious gas, for example hydrogen sulfide to create a stabilize form of iron sulfide. This removes the noxious gas from the gases being extracted for use and sale.

Inner pipe 141 may be a conduit that connects the reservoir 190 to the surface. The inner pipe 141 may define a vertical channel 144. Inner pipe may include and outer surface 146. The outer surface 146 of the inner pipe 141 may include openings/perforations 148 to allow fluid to flow into the inner pipe 141. In some embodiments, these perforations 148 align with the perforations 154 of the outer pipe 150. Reservoir fluids flow from the reservoir 190, through the perforations 154 in the outer pipe 150, through the perforation 148 in the inner pipe 141 into the channel 144 defined by the inner pipe 141, and up the well 100 to the surface for collection or onsite use.

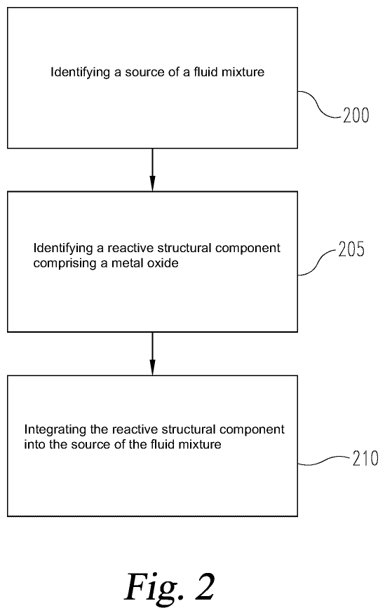

FIG. 2 is a flowchart illustrates a method for reducing noxious gas from a fluid mixture extracted from a source of methane/hydrogen sulfide. A source of methane may be identified for extraction, for example from a landfill 200. Often, the source of methane may include noxious gases, for example hydrogen sulfide.

Next, a reactive structural component comprising a metal oxide may be identified 205. For example, iron oxide may be utilized. The reactive structural component may be packed into a landfill well. In some example,. the metal oxide may be FeO. The reactive structural component may include a Waelz slag.

Next, the reactive structural component is integrated into the source of the hydrogen sulfide 210. In some embodiments, the landfill well filled with a metal oxide may be inserted into the source of the hydrogen sulfide. The hydrogen sulfide may contact and react with the structural component to produce a metal sulfide. At least a portion of the fluid mixture may be extracted.

While the present disclosure has been illustrated and described in detail in the drawings and the foregoing description, the same is to be considered as illustrative and not restrictive in character, it being understood that only the preferred embodiment has been shown and described and that all changes and modifications that come within the spirit of the disclosure are desired to be protected. In addition, all references cited herein are indicative of the level of skill in the art and are hereby incorporated by reference in their entirety.

### EMBODIMENTS

The following provides an enumerated listing of some of the embodiments disclosed herein. It will be understood that this listing is non-limiting, and that individual features or combinations of features (e.g., 2, 3 or 4 features) as described in the Detailed Description above can be incorporated with the below-listed Embodiments to provide additional disclosed embodiments herein.

1. A method comprising:
identifying a source of hydrogen sulfide;
identifying a reactive structural component comprising a metal oxide; and
integrating the reactive structural component into the source of hydrogen sulfide,
wherein the hydrogen sulfide contacts the reactive structural component to produce a metal sulfide.

2. The method of any one of the preceding embodiments, wherein the metal oxide comprises an iron oxide.

3. The method of any one of the preceding embodiments, wherein the metal oxide comprises FeO.

4. The method of any one of the preceding embodiments, wherein the reactive structural component comprises a Waelz slag.

5. The method of any one of the preceding embodiments, wherein the source of hydrogen sulfide is a landfill.

6. The method of any one of the preceding embodiments, wherein the landfill comprises a wellhead for evacuating hydrogen sulfide.

7. The method of any one of the preceding embodiments, wherein the reactive structural component is packed within the wellhead.

8. A well comprising:
an elongated piping system including an outer pipe and an inner pipe, wherein the outer pipe includes openings defining a fluid path that extends through the outer pipe, wherein the outer pipe is filled with a reactive structural component including metal oxide;
wherein the inner pipe is nested within the outer pipe and defines a channel through a length of the inner pipe, wherein the inner pipe includes openings defining a fluid path operably connected to the fluid path of the outer pipe that extends through the inner pipe into the channel; and
wherein a fluid from a reservoir flows into the well through fluid path defined by the openings in the outer pipe and into the channel of the inner pipe, and wherein the fluid is collected.

9. The well of any one of the preceding embodiments, wherein the metal oxide is iron oxide.

10. The well of any one of the preceding embodiments, wherein the metal oxide comprises FeO.

11. The well of any one of the preceding embodiments, wherein the reservoir is a landfill.

12. A method for reducing noxious gas from a location comprising:
identifying a location containing hydrogen sulfide;
packing a well with a reactive structural component comprising a metal oxide;
inserting the well into the location containing hydrogen sulfide; and
extracting a gaseous mixture from the location, wherein the reactive structural component reacts with the hydrogen sulfide to remove it from the gaseous mixture being extract, wherein a metal sulfide is produced.

13. The method of any one of the preceding embodiments, wherein the metal oxide is iron oxide.

14. The method of any one of the preceding embodiments, wherein the well is a vertical well.

15. The method of any one of the preceding embodiments, wherein the gaseous mixture comprises methane and hydrogen sulfide.

16. The method of any one of the preceding embodiments, wherein the metal sulfide is iron sulfide.

17. The method of any one of the preceding embodiments, wherein the location is a landfill.

18. The method of any one of the preceding embodiments, wherein the metal oxide is at least 50% of the reactive structural component composition.

19. The method of any one of the preceding embodiments, wherein the reactive structural component comprises a Waelz slag.

20. The method of any one of the preceding embodiments, wherein the metal oxide comprises FeO.

1. A method comprising:
identifying a source of hydrogen sulfide;
identifying a reactive structural component comprising a metal oxide; and
integrating the reactive structural component into the source of hydrogen sulfide, wherein the hydrogen sulfide contacts the reactive structural component to produce a metal sulfide.

2. The method of claim 1, wherein the metal oxide comprises an iron oxide.

3. The method of claim 1, wherein the metal oxide comprises FeO.

4. The method of claim 1, wherein the reactive structural component comprises a Waelz slag.

5. The method of claim 1, wherein the source of hydrogen sulfide is a landfill.

6. The method of claim 5, wherein the landfill comprises a wellhead for evacuating hydrogen sulfide.

7. The method of claim 6, wherein the reactive structural component is packed within the wellhead.

8. A well comprising:
an elongated piping system including an outer pipe and an inner pipe, wherein the outer pipe includes openings defining a fluid path that extends through the outer pipe, wherein the outer pipe is filled with a reactive structural component including metal oxide;
wherein the inner pipe is nested within the outer pipe and defines a channel through a length of the inner pipe, wherein the inner pipe includes openings defining a fluid path operably connected to the fluid path of the outer pipe that extends through the inner pipe into the channel; and
wherein a fluid from a reservoir flows into the well through fluid path defined by the openings in the outer pipe and into the channel of the inner pipe, and wherein the fluid is collected.

9. The well of claim 8, wherein the metal oxide is iron oxide.

10. The well of claim 8, wherein the metal oxide comprises FeO.

11. The well of claim 8, wherein the reservoir is a landfill.

12. A method for reducing noxious gas from a location comprising:
identifying a location containing hydrogen sulfide;
packing a well with a reactive structural component comprising a metal oxide;
inserting the well into the location containing hydrogen sulfide; and
extracting a gaseous mixture from the location, wherein the reactive structural component reacts with the hydrogen sulfide to remove it from the gaseous mixture being extract, wherein a metal sulfide is produced.

13. The method of claim 12, wherein the metal oxide is iron oxide.

14. The method of claim 12, wherein the well is a vertical well.

15. The method of claim 12, wherein the gaseous mixture comprises methane and hydrogen sulfide.

16. The method of claim 12, wherein the metal sulfide is iron sulfide.

17. The method of claim 12, wherein the location is a landfill.

18. The method of claim 12, wherein the metal oxide is at least 50% of the reactive structural component composition.

19. The method of claim 12, wherein the reactive structural component comprises a Waelz slag.

20. The method of claim 12, wherein the metal oxide comprises FeO.
